(19) United States
(12) Patent Application Publication
(10) Pub. No.: US 2004/0080068 A1
(43) Pub. Date: Apr. 29, 2004

(54) Process of producing porous films

(75) Inventors: Shinichi Ooizumi, Ibaraki-shi (JP); Kazushige Yamamoto, Ibaraki-shi (JP); Tomoaki Ichikawa, Ibaraki-shi (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION

(21) Appl. No.: 10/689,039

(22) Filed: Oct. 21, 2003

(30) Foreign Application Priority Data
Oct. 28, 2002 (JP) 2002-312507

(51) Int. Cl. B29C 47/00

(52) U.S. Cl. 264/41; 264/210.2

(57) ABSTRACT

A process of producing porous films having a high porosity and excellent air permeability, even though they have a small film thickness and a high strength, and a process of producing battery separators. The process of producing porous films includes the steps of melt kneading a composition comprising a polyolefin resin, a thermoplastic elastomer and a solvent; extruding and cooling the melt kneaded material into a sheet molding; rolling the sheet molding; and stretching and desolvating the rolled sheet molding, wherein the rolling is carried out under a condition such that the sheet molding after rolling has an elastic recovery rate as calculated by the following equation (1) of 20% or lower:

Elastic recovery rate (r) (%)=100×(t−t₀)/t₀ (1)

wherein t₀ represents a minimum clearance of a sheet rolling section in the rolling; and t represents a sheet thickness in the elastic recovery state after pressure release.

### FIELD OF THE INVENTION

The present invention relates to a process of producing porous films and a process of producing battery separators. More specifically, the present invention relates to a process of producing porous films that are suitably used as a battery separator that is disposed between a positive electrode and a negative electrode in a battery to isolate these electrodes from each other for the purpose of preventing shortcut between the positive electrode and the negative electrode.

### DESCRIPTION OF THE RELATED ART

At present, lithium secondary batteries are largely used for potable telephones and notebook personal computers, and further, are expected as batteries for electric automobiles.

As negative electrode materials of such lithium batteries, not only metallic lithium but also lithium alloys and interlaminar compounds capable of occluding and releasing lithium ion, such as carbon materials, can be enumerated. As positive materials, oxides of transition metals such as cobalt, nickel, manganese or iron, and composite oxides of such transition metals and lithium can be enumerated.

In general, in such lithium batteries, a separator is provided between the positive electrode and the negative electrode for the purpose of preventing shortcut between these electrodes. As such a separator, porous films having a large number of fine pores are usually used for the purpose of ensuring ion permeation between the positive electrode and the negative electrode.

As such porous films of battery separator, there are known various production processes as trials to realize thin film thickness and high strength. Especially, a process of producing porous films by extrusion molding a composition obtained by heating and melting a polyolefin resin composed mainly of an ultrahigh molecular weight polyolefin resin in a solvent into a gel-like sheet, rolling the extruded sheet molding, and then stretching and desolvating the rolled sheet molding is a superior process for obtaining battery separators having a thin film thickness and a high strength and having a high pore volume.

Specifically, a process of producing porous films by molding a composition obtained by heating and melting an ultrahigh molecular weight polyolefin resin in a solvent into a sheet form through a cooled sizing die, rolling the sheet molding by a belt pressing machine, and then stretching and desolvating the rolled sheet molding is known as disclosed in, for example, JP-A-2000-230072, page 2. Further, a process of producing porous films in which in a similar production process, the product of a rolling ratio in the rolling step and a stretching ratio in the stretching step is adjusted at from 50 to 400 times, and a ratio of the rolling ratio to the stretching ratio is adjusted at from 1 to 15, is known as disclosed in, for example, JP-A-2000-272019, page 2.

However, the inventions of the above-described patent documents are concerned with a process of producing porous films using a thermoplastic elastomer-free resin composition as the raw material, and it is considered that the behavior of elastic recovery in the rolling processing is largely different from that in the case where a thermoplastic elastomer is contained. Further, although JP-A-2000-230072 mentions the relationship between the elastic recover of sheet moldings and the cooling temperature in the cold rolling step, even in the case where the cooling temperature is sufficiently low, the behavior of elastic recovery largely differs depending upon other rolling conditions.

On the other hand, in porous films for battery separator, in the case where an abnormal current is generated due to false connection, etc., a so-called shutdown function (SD function) in which as the internal temperature of battery increases, the resin causes deformation and clogs fine pores, thereby stopping cell reaction is required from the viewpoint of safety. For revealing such an SD function, it is known effective to contain a thermoplastic elastomer in the porous film.

However, according to investigations made by the present inventors, it has become clear that in the case where the raw material contains a thermoplastic elastomer, the elastic recovery rate of a sheet molding after rolling influences a porosity and other characteristics of the resulting porous film. This is especially important in obtaining porous films having a thin film thickness and a high strength.

Accordingly, one object of the present invention is to provide a process of producing porous films having a high porosity and excellent air permeability, even though they have a thin film thickness and a high strength.

Another object of the present invention is to provide a process of producing battery separators.

As a result of extensive and intensive investigations regarding various production conditions on a basis of the above knowledge, it has been found that the above-described objects can be attained by adjusting an elastic recovery rate of a sheet molding after rolling within a specific range. The present invention has been completed based on this finding.

The process of producing porous films according to the present invention comprises the steps of melt kneading a composition comprising a polyolefin resin, a thermoplastic elastomer and a solvent; extruding and cooling the melt kneaded material into a sheet molding; rolling the sheet molding; and stretching and desolvating the rolled sheet molding, wherein the rolling is carried out under a condition such that the sheet molding after rolling has an elastic recovery rate as calculated by the following equation (1) of 20% or less:

Elastic recovery rate (r) (%)=100×(t−t₀)/t₀ (1)

wherein t₀ represents a minimum clearance of a sheet rolling section in the rolling; and t represents a sheet thickness in the elastic recovery state after pressure release.

In the above process, the rolling is preferably carried out under a condition such that a rolling coefficient k as calculated by the following equation (2) is 5 (times·min) or more.

Rolling coefficient (k) (times-min)=Rolling ratio (times)×Rolling time (min) (2)

wherein the rolling ratio means a ratio obtained by dividing a sheet thickness before rolling by a sheet thickness after rolling; and the rolling time means a time when a pressure is acting.

Further, the rolling is preferably carried out by a pressure roller type double belt pressing machine. During this processing, the pressure roller type double belt pressing machine is preferably one in which heat rolling and cold pressurizing are continuously carried out within one belt pressing machine.

Especially preferably, the heat rolling is carried out at a temperature between (the melting point of the polyolefin resin −30° C.) and (the melting point of the polyolefin resin −10° C.), and the cold pressurizing is carried out at 40° C. or lower.

The composition preferably contains a crosslinkable, double bond-containing thermoplastic elastomer.

The process of producing battery separators according to the present invention is conducted by the process of producing porous films as described above.

### BRIEF DESCIRPTION OF THE STRETCHING

The FIGURE is a schematic configuration showing one embodiment using an apparatus used in the process of producing porous films according to the present invention.

In the FIGURE:

1: Drum

2: Drive drum

3: Endless belt

4: Heat pressure roller

5: Cold pressure roller

FIG. 6: Feed nip roller

### DETAILED DESCRIPTION OF THE INVENTION

The embodiment of the present invention will be described below by reference to the accompanying stretching. The FIGURE is a schematic configuration showing one embodiment using an apparatus used in the process of producing porous films according to the present invention.

In the production process of the invention, the apparatus as shown in the FIGURE, for example, is used, and a composition containing a raw material resin is melt kneaded, extruded in an extrusion section, and cooled in a cooling section to form a sheet molding, which is then rolled by passing through a heat pressurizing section and a cold pressurizing section. The sheet molding is delivered by feed nip rollers 6, heat rolled by heat pressure rollers 4 while being fed by movement of endless belts 3 each engaging a drum 1 and a drive drum 2, and then subjected to cold pressurizing by cold pressure rollers 5. Subsequently, the resulting sheet is drawn and desolvated by a unit (not shown).

In the present invention, first of all, a composition comprising a polyolefin resin, a thermoplastic elastomer and a solvent is melt kneaded. Such a polyolefin resin preferably contains an ultrahigh molecular weight polyolefin. Examples of the ultrahigh molecular weight polyolefin include homopolymers or copolymers of ethylene, propylene, 1-butene, 4-methyl-1-pentene, 1-hexene, etc., and mixtures thereof. Of those resins, ultrahigh molecular weight polyethylene resins are preferably used from the standpoint of high strength of the resulting porous films.

The ultrahigh molecular weight polyolefin has a weight average molecular weight of 5×10⁵ or more, preferably from 5×10⁵ to 20×10⁶, and more preferably from 5×10⁵ to 15×10⁶. The weight average molecular weight used herein means a value measured by the measurement method described in the Examples using a gel permeation chromatograph (GPC).

The content of the ultrahigh molecular weight polyolefin resin in the polyolefin resin is preferably from 5 to 100% by weight, and more preferably from 8 to 100% by weight, based on the weight of the polyolefin resin.

Resins other than the ultrahigh molecular weight polyolefin resin may be contained in the polyolefin resin, and the examples thereof include homopolymers or copolymers of ethylene, propylene, 1-butene, 4-methyl-1-pentene, 1-hexene, etc., and mixtures thereof. Of those resins, high density polyethylene resins are preferably used from the standpoint of high strength of the resulting porous films. Those resins have a weight average molecular weight of preferably from 1×10⁴ to less than 5×10⁵, and more preferably from 1×10⁴ to 3×10⁵.

The solvent that can be used is not particularly limited so long as it has excellent solubility against the polyolefin resin. Solvents having a solidifying point of −10° C. or lower are preferably used. Preferable examples of such solvents include aliphatic or alicyclic hydrocarbons, such as decane, decalin or liquid paraffins, and mineral oil fractions having a boiling point corresponding to these hydrocarbons. Of those, non-volatile solvents such as liquid paraffins are preferable, and non-volatile solvents having a solidifying point of from −45 to −10° C. and a dynamic viscosity at 40° C. of 65 (m²/s) or lower are more preferable.

Examples of the thermoplastic elastomer include thermoplastic elastomers such as polystyrene based, polyolefin based, polydiene based, vinyl chloride based or polyester based elastomers. Examples of the crosslinkable, double bond-containing thermoplastic elastomer include polybutadiene, polynorbornene, polyisoprene, and unvulcanized products of other crosslinkable rubbers. Especially, polynorbornene and rubbers comprising a terpolymer of ethylene, propylene and a diene monomer (EPDM) in which the diene component is ethylidene norbornene are preferable. Such a thermoplastic elastomer is contained in an amount of preferably from 1 to 50% by weight, and more preferably from 2 to 40% by weight, in the porous film.

The mixing proportion of the polyolefin, thermoplastic elastomer and solvent varies depending on the kind and solubility of polyolefin, the kneading temperature, etc., and therefore, cannot be unequivocally defined. So far as the resulting resin composition in a slurry form can be melt kneaded and molded into a sheet form, the mixing proportion is not particularly limited. For example, the mixing proportion of the total amount of the polyolefin resin and the thermoplastic elastomer is preferably from 5 to 30% by weight, and more preferably from 8 to 20% by weight, in the resin composition. When the mixing proportion of the total amount of the polyolefin resin and the thermoplastic elastomer is 5% by weight or more, it is possible to enhance the strength of the resulting porous film. Further, when the mixing proportion of the total amount of the polyolefin resin and the thermoplastic elastomer is 30% by weight or less, since the polyolefin resin and the thermoplastic elastomer can be sufficiently dissolved in the solvent and kneaded closed to the state that the composition extends to its full length, it is possible to obtain sufficient entanglement of polymer chains.

If desired, it is possible to add additives, such as antioxidants, ultraviolet absorbers, dyes, nucleating agents, pigments or antistatic agents, to the resin composition within the range where the object of the invention is not hindered.

For obtaining sufficient entanglement of polymer chains of the polyolefin resin, melt kneading the resin composition is preferably performed by acting a sufficient shear force to the resin composition. Accordingly, kneaders and twin-screw kneaders that can usually impart a strong shear force to mixtures are preferably used in melt kneading the resin composition.

The temperature in melt kneading the resin composition is not particularly limited so far as the melt kneading is conducted under an appropriate temperature condition. The temperature is preferably from 115 to 185° C. For sufficiently kneading the resin composition to obtain sufficient entanglement of polymer chains of the polyolefin resin, the melt kneading temperature is preferably 115° C. or higher. For acting a sufficient shear force to the resin composition at a suitable viscosity, the melt kneading temperature is preferably 185° C. or lower.

The resulting melt kneaded material is extruded and then cooled to mold it into a sheet form. The method of molding the melt kneaded material into a sheet form is not particularly limited. For example, the melt kneaded material may be sandwiched between cooled metal plates and quenched for quenching crystallization (solidification) to form it into a sheet molding, or the melt kneaded material may be molded into a sheet form using an extruder equipped with a T die, etc., and then cooled for crystallization. For cooling the melt kneaded material, conventionally employed cooling rollers, etc., can be used without particular limitations. However, for finely crystallize the polyolefin resin in not only the surface layer but also the core of the sheet molding, a sizing die is preferably used.

Since the melt kneaded material is molded into a sheet form while stabilizing the movement of the solvent, it is desired that the temperature of the sizing die (i.e., cooling temperature) is −15° C. or lower, and preferably −20° C. or lower.

The method of cooling the sizing die is, for example, a method in which a conduit is provided within the sizing die, and an antifreezing solution previously diluted with water is circulated in a constant circulation amount within the conduit. For further enhancing a cooling ability, a method in which a cooling tank is provided within the sizing die, and the antifreezing solution previously diluted with water is circulated within the cooling tank may be employed. Whenever any method is employed, it is preferred to make a difference in temperature of the cooling solution between an inlet and an outlet small as far as possible, eliminate a temperature unevenness or temperature gradient, and increase a cooling efficiency. Further, if desired, the sheet molding may be drawn while applying a tension by take-up rollers.

The thickness of the thus obtained sheet molding is preferably from 0.5 to 20 mm, and more preferably from 5 to 10 mm, for the reason that the polyolefin resin is finely crystallized in not only the surface layer but also the core of the sheet molding. Incidentally, in the case where rolling is carried out using a belt pressing machine, etc., the width of the sheet molding is preferably from 50 to 200 mm.

For obtaining porous films having a porous film structure having a large path curvature and comprising thin and uniform fibrils by finely crystallizing the polyolefin film in not only the surface layer but also the core of the sheet molding, it is desired to quench the melt kneaded material preferably at −15° C. or lower, and more preferably at −20° C. or lower, to mold it into sheet form.

The reason for this is that in the solution state, i.e., in the case where the cooling rate is low during molding the melt kneaded material into a sheet form, the sheet is stretched by melt kneading, and the entangled fibrils are turned into a wool ball state to form thick fibers. However, since sheet moldings in a gel state do not generally have large heat conductivity, portions near the core are difficult to be cooled as compared with the surface layer. However, in the case where the cooled sizing die is used, it is possible to suppress cooling unevenness of the melt mixture due to heat conduction of a metal. Further, since the melt mixture passes through a high precision space under a prescribed pressure, it is possible to markedly enhance shape stability of the resulting sheet molding.

For preventing the formation of big through-holes in the sheet molding, caused by a phenomenon in which the thus obtained sheet molding is stretched by melt kneading, and the entangled fibril fibers are returned into a wool ball state to form thick fibers, it is preferred to immediately provide the sheet molding for the rolling processing described hereinafter or store the same at a temperature of the solidifying point or lower of the solvent used, thereby maintaining the crystal structure of the polyolefin resin.

The sheet molding is then subjected to rolling processing. For the rolling processing, it is preferred to use a belt pressing machine capable of uniformly rolling the sheet molding. The belt pressing machine as referred to herein means one having a structure that a sample is sandwiched between belts and rolled. Such a belt pressing machining enables to undergo continuous rolling processing because the belts can move at a constant rate by a drive drum.

The belt pressing machine used for the rolling processing is not particularly limited so far as it has the above-described structure. Examples of useful belt pressing machines include hydraulic-operated double belt pressing machines using presses for pressurizing, roller type double belt pressing machines using pressure rollers, belt grasping belt pressing machines, and rotocures. Of those, roller type double belt pressing machines are preferable from the standpoint of flexibility of gap adjustment.

The preferred embodiment in the present invention is that the sheet molding after rolling has an elastic recovery rate as calculated by the following equation (1) of 20% or lower, and preferably from 0 to 10%. When this elastic recovery rate exceeds 20%, not only the thickness of the sheet is not stable, but also high porosity and high air permeability cannot be obtained.

Elastic recovery rate (r) (%)=100×(t−t₀)/t₀ (1)

wherein t₀ represents a minimum clearance of a sheet rolling section in the rolling; and t represents a sheet thickness in the elastic recovery state after pressure release.

In further preferred embodiment, a rolling coefficient k as calculated by the following equation (2) is preferably 5 (times-min) or more, and more preferably from 5 to 200 (times·min). When the rolling coefficient k is less than 5 (times·min), the elastic recovery rate is large, and the strength is low. On the other hand, when it exceeds 200 (times·min), it is required to employ a large-scale system such that a large pressure is applied so as to resist to a repulsion generated during rolling of the sheet molding or that a pressure zone length is prolonged.

Rolling coefficient (k) (times-min)=Rolling ratio (times)×Rolling time (min) (2)

wherein the rolling ratio means a ratio obtained by dividing a sheet thickness before rolling by a sheet thickness after rolling, and the rolling time means a time when a pressure is acting.

In the case conducting heat rolling and cold pressuring, the rolling time means a time from the start of the heat rolling until completion of the cold pressurizing. In order to satisfy the above-described conditions of rolling coefficient, the rolling ratio is preferably from 0.5 to 20 times, and the rolling time is preferably from 0.5 to 10 minutes.

The pressure roller type double belt pressing machine is preferably one in which heat rolling and cold pressurizing are continuously carried out within one belt pressing machine. The temperature during the heat rolling is preferably a temperature between (the melting point of the polyolefin resin −30° C.) and (the melting point of the polyolefin resin −10° C.), and more preferably a temperature between (the melting point of the polyolefin resin −20° C.) and (the melting point of the polyolefin resin −15° C.). That is, for making it easy to decrease the film thickness by rolling, a temperature of (the melting point of the polyolefin resin −30° C.) or higher is preferable, and for ensuring the strength and uniformity of the thickness during using the resulting porous film as a battery separator, a temperature of (the melting point of the polyolefin resin −10° C.) or lower is preferable. The melting point of the polyolefin resin as used herein means an endothermic peak value temperature during the temperature elevation step in the DSC measurement described in the Examples.

The temperature during the cold pressurizing is preferably 40° C. or lower, and more preferably from 10 to 20° C. That is, for preventing the elastic recovery of the sheet molding after heat rolling while maintaining the rolling state and making the thickness of the sheet uniform, the temperature during the cold pressurizing is preferably 40° C. or lower.

Further, it is possible to provide a feeding device before the heat belt pressing machine and provide a difference between a feeding speed and a line speed of the heat belt pressing machine. By providing a difference between the line speed of the heat belt pressing machine and the feeding speed of the feeding device, an effect for suppressing meander during the sheet pressing can be expected, thereby making it possible to increase the yield.

The method of making the rolling ratio during rolling large is, for example, a method of adjusting a gap between pressure rollers. By setting up such that the rolling ratio becomes rapidly large, the sheet molding slides between the belts, and biting becomes insufficient, whereby the sheet molding is not rolled.

The number of pairs of pressure rollers is not particularly limited, but in general, is preferably from about 10 to 30. Further, a biting angle of the pressure rollers is not particularly limited, but is preferably from 0 to 1°, and more preferably from 0 to 0.5°. The biting angle as referred to herein means an angle of the belt surface against the traveling horizontal direction of the sheet molding, and the belt surface as referred to herein means a region where the sheet molding is bitten and rolled.

In heat rolling, taking into account smooth biting of the sheet molding, it is preferred that the sheet molding is heat rolled between the belts with a biting angle, and in the cold pressurizing, the biting angle is made 0° so as to reach the desired rolling ratio, thereby making the gap constant.

For increasing a coefficient of friction between the belt surface and the sheet molding to make biting good, it is also possible to employ a method of controlling a surface roughness of the belt surface or a method in which the sheet molding is sandwiched between oil trap sheets such as papers and rolled.

The rolling by pressing is a kind of solid phase processing, and the resin composition is processed in a high-viscosity state. Accordingly, a shear flow generating molecular friction inside the resin causes brittle fracture so that uniform rolling becomes difficult. For achieving ideal biaxial stretching, it is necessary to make the flow resistance as small as possible, thereby fluidizing the resin composition as a uniform plug flow. For achieving this, a lubricant may be present between the resin composition and the belt surface. In the resin composition comprising a polyolefin resin and a solvent according to the present invention, the solvent bleeds out between the composition and the belt surface during the rolling processing, thereby playing a role as a lubricant. In meaning of expecting such a behavior, the resin composition comprising a polyolefin resin and a solvent preferably contains the solvent in an amount of 70% by weight or more.

The stretching treatment method is not particularly limited, and usually, examples thereof include a tenter method, a roller method, an inflation method, and combinations thereof Any of uniaxial stretching and biaxial stretching may be applied. In the case of biaxial stretching, any of simultaneous stretching in the machine direction and transverse direction or sequential stretching may be employed, with simultaneous stretching in the machine direction and transverse direction being preferred. The temperature during the stretching treatment is preferably a temperature of (the melting point of the polyolefin+5° C.) or lower. As other stretching treatment conditions, conventional conditions can be employed.

The sheet molding is subjected to desolvation treatment. The desolvation treatment is a step of removing the solvent from the sheet molding to form a porous structure, and can be carried out by, for example, rinsing the sheet molding with a diluent to remove the solvent.

The diluent can appropriately be selected depending on the solvent used for the preparation of the resin composition. Examples of the diluent used include easily volatile solvent media such as hydrocarbons (e.g., pentane, hexane, heptane or decane); chlorinated hydrocarbons (e.g., methylene chloride or carbon tetrachloride); ethers (e.g., diethyl ether or dioxane); and alcohols. Those may be used alone or as mixtures of two or more thereof The desolvation treatment method using such a diluent is not particularly limited, and examples thereof include a method in which the sheet molding is dipped in a diluent to extract the solvent and a method in which a diluent is showered on the sheet molding.

The desolvation treatment may be carried out prior to the stretching. For example, the sheet molding may be subjected to the stretching treatment after desolvating the sheet molding, or the sheet molding may be subjected to the desolvation treatment after stretching. Alternatively, an embodiment may be employed in which the sheet molding is subjected to desolvation prior to stretching and again subjected to desolvation after stretching to remove the residual solvent.

The thus obtained porous film may further be subjected to heat setting for preventing heat shrinkage of the film, etc., to fix the shape, if required and necessary.

The thus obtained porous film desirably has a thickness of from 1 to 60 μm, and preferably from 5 to 45 μm. Further, it is preferred from the standpoint of use as battery separators that the resulting porous film has a porosity of from 35 to 75%, an air permeability of from 100 to 800 seconds/100 cc, and a needle penetration strength of 200 g/16 μm or more.

The present invention will be described in more detail by reference to the following Examples, but it should be understood that the invention is not construed as being limited thereto. Various characteristics were measured in the following manners.

### Melting Point

Using a differential scanning calorimeter “DSC 200” manufactured by Seiko Instruments Inc., the temperature is elevated from room temperature to 200° C. at a rate of 10° C./min, and an endothermic peak value during this temperature elevation step is defined as a melting point.

### Weight Average Molecular Weight

Using a gel permeation chromatograph “GPC-150C” manufactured by Waters Corporation, the measurement is carried out at a temperature of 135° C. using o-dichlorobenzene as a solvent and a column “Shodex-80M” manufactured by Showa Denko K.K. The data processing is carried out using a data processing system made by TRC Corp. The molecular weight is calculated on a basis of polystyrene.

### Film Thickness

Using a 1/10000 thickness gauge, the film thickness was measured from a scanning electron microscopic photograph of 10,000 magnifications of the cross section of porous film.

### Porosity

Using a mercury porosimeter (Autoscan 33, manufactured by Yuasa Ionics Inc.), a pore volume (ml/g) was determined on a basis of the following equation while defining the density of polyolefin at 0.95 (g/ml).

Porosity (%)=[(pore volume)/{(pore volume)+(1/density)}]×100

### Air Permeability

Gurley value is measured according to JIS P8117.

### Needle Penetration Strength

The needle penetration strength is measured using a handy compression tester “KES-G5” manufactured by Kato-Tech Co., Ltd. The measurement is carried out using a needle having a diameter of 1.0 mm and a tip shape of 0.5 mm at a holder diameter of 11.3 mm and an indentation rate of 2 mm/sec, and a maximum load until the film has broken is defined as the needle penetration strength. All of the values are converted to a film thickness of 25 μm.

### EXAMPLE 1

15 parts by weight of a polymer composition consisting of 73% by weight of ultrahigh molecular weight polyethylene having a weight average molecular weight of 1,500,000, 13% by weight of EPDM (ethylidene norbornene content: 10% by weight, “Esprene 505” manufactured by Sumitomo Chemical Co., Ltd.), and 14% by weight of a thermoplastic elastomer (“TPE821”, manufactured by Sumitomo Chemical Co., Ltd.) and 85 parts by weight of a liquid paraffin were uniformly mixed in a slurry state. The slurry was fed at a treatment amount of 20 kg/hr into a twin-screw extruder (cylinder diameter: 40 mm, L/D=42) and melt kneaded while heating at a temperature of 160° C. The kneaded material was extruded into a sheet form using a fish taildie equipped at the tip of the twin-screw extruder, and immediately thereafter, was passed through a sizing die cooled at −15° C. for quenching solidification.

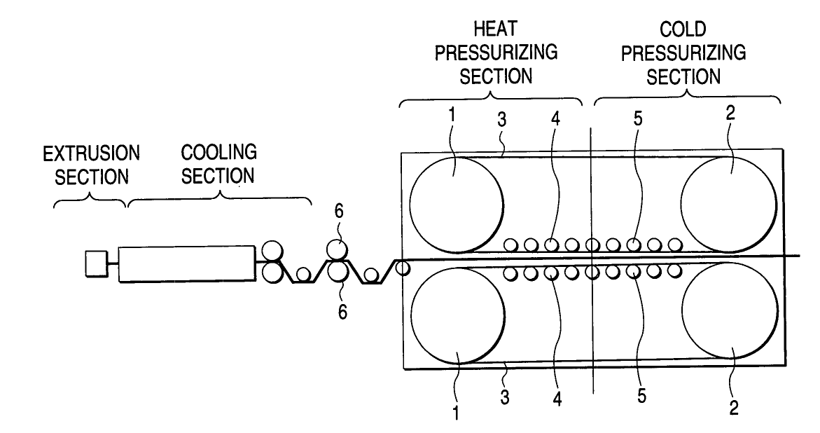

The resulting sheet molding (thickness: 6.5 mm) was pressurized at a temperature of about 127° C. using a pressure roller type double belt pressing machine (biting angle: 0.5°) as shown in FIG. 1 and rolled into 1.15 mm, followed by cold pressurizing at 30° C. using a cold pressure roller type double belt pressing machine (biting angle: 0°). The rolling ratio was 5.6 times, the rolling time from start of the heat rolling until completion of the cold pressurizing was 6 minutes, the rolling coefficient k was 33.6 (times·min), and the elastic recovery rate r was 5%. Further, the sheet molding was biaxially stretched simultaneously at ratios in the machine direction and transverse direction of 4.5 times and 5 times, respectively, at 125° C. The resulting sheet was subjected to desolvation by dipping the same in heptane. The thus obtained porous film was further heat treated in air at 85° C. for 1 hour and then heat treated at 116° C. for 1.5 hours to obtain a finely porous film. This porous film had a thickness of 16 μm.

### EXAMPLE 2

A porous film having a thickness of 12 μm was obtained in the same manner as in Example 1, except that the size of the sizing die was changed to obtain a sheet molding (thickness: 9 mm), which was then pressurized at a temperature of about 127° C. using the heat pressure roller type double belt pressing machine, rolled into 1.11 mm, and then subjected to cold pressurizing at 30° C. using the cold pressure roller type double belt pressing machine. In this case, the rolling ratio was 8.1 times, the rolling time was 6 minutes, the rolling coefficient k was 48.6 (times·min), and the elastic recovery rate r was 1%.

### EXAMPLE 3

A porous film having a thickness of 18 μm was obtained in the same manner as in Example 1, except that a sheet molding (thickness: 6.5 mm) was pressurized at a temperature of about 127° C. using the heat pressure roller type double belt pressing machine, rolled into 1.3 mm, and then subjected to cold pressurizing at 40° C. using the cold pressure roller type double belt pressing machine. In this case, rolling ratio was 5.0 times, the rolling time was 1 minute, the rolling coefficient k was 5 (times·min), and the elastic recovery rate r was 18%.

### COMPARATIVE EXAMPLE 1

A porous film having a thickness of 20 μm was obtained in the same manner as in Example 1, except that a sheet molding (thickness: 6.5 mm) was pressurized at a temperature of about 127° C. using the heat pressure roller type double belt pressing machine, rolled into 1.33 mm, and then subjected to cold pressurizing at 30° C. using the cold pressure roller type double belt pressing machine. At this time, rolling ratio was 4.9 times, the rolling time was 1 minute, the rolling coefficient k was 4.9 (times·min), and the elastic recovery rate r was 21%.

### COMPARATIVE EXAMPLE 2

A porous film having a thickness of 25 μm was obtained in the same manner as in Example 1, except that a sheet molding (thickness: 6.5 mm) was pressurized at a temperature of about 127° C. using the heat pressure roller type double belt pressing machine, rolled into 1.5 mm, and then subjected to cold pressurizing at 50° C. using the cold pressure roller type double belt pressing machine. At this time, rolling ratio was 4.3 times, the rolling time was 1 minute, the rolling coefficient k was 4.3 (times·min), and the elastic recovery rate r was 36%.

The obtained porous films were evaluated for the above-described characteristics. The results obtained are shown in the following Table along with the rolling conditions.

| | | | | | | | | Needle |
|---|---|---|---|---|---|---|---|---|
| | | | Rolling | Elastic | Film | | | penetration |
| | Rolling ratio | Rolling time | coefficient | recovery rate | thickness | Porosity | Gurley | strength |
| | (times) | (min) | (time · min) | (%) | (μm) | (%) | (sec/100 cc) | (g) |
| Example 1 | 5.6 | 6 | 33.6 | 5 | 16 | 38 | 270 | 380 |
| Example 2 | 8.1 | 6 | 48.6 | 1 | 12 | 40 | 200 | 400 |
| Example 3 | 5 | 1 | 5 | 18 | 19 | 36 | 350 | 370 |
| Comparative | 4.9 | 1 | 4.9 | 21 | 20 | 30 | 400 | 190 |
| Example 1 | | | | | | | | |
| Comparative | 4.3 | 1 | 4.3 | 3.6 | 24 | 25 | 500 | 180 |
| Example 2 | | | | | | | | |

It can be understood from the above results that since the porous films obtained in Examples 1 to 3 are proper with respect to the elastic recovery rate and rolling coefficient, those are thin films having proper values in porosity, air permeability and needle penetration strength. On the other hand, in Comparative Examples 1 and 2 in which the rolling coefficient is low, and the elastic recovery rate is too large, the porosity, air permeability and needle penetration strength were low.

According to the production process of the present invention, the elastic recovery rate of a sheet molding after rolling is adjusted at 20% or lower. Therefore, even in the case where a thermoplastic elastomer is contained, it is possible to produce porous films having high porosity and excellent air permeability even though they have small film thickness and high strength, as shown in the Examples described hereinabove. The details of the reasons are not always clear, but it may be assumed as follows. That is, in the case where a thermoplastic elastomer is contained, the elastic recovery rate of sheet moldings after rolling is liable to become large under conventional conditions, and the orientation state of molecular chains at the time of elastic recovery cannot be maintained. As a result, it is difficult to effectively perform post stretching. In contrast, according to the production process of the present invention, the orientation state of molecular chains after rolling can be suitably maintained. Therefore, post stretching can be effectively performed so that it is possible to obtain porous films having high porosity and excellent air permeability, even though they have small film thickness and high strength.

Further, in the case where the rolling coefficient in the rolling step is 5 (times·min) or more, since the rolling is sufficiently carried out while taking a lot of time, it is possible to decrease the elastic recovery rate. Accordingly, it is possible to obtain more surely high-porosity porous films having small film thickness and high strength.

In the case where the rolling is carried out using a pressure roller type double belt pressing machine, it becomes possible to perform the rolling in a continuous manner, and continuity of pressurizing in the MD direction (machine direction) and uniformity of pressure on the entire surface to be pressurized become suitable.

In the case where the pressure roller type double belt pressing machine is one in which heat rolling and cold pressurizing are continuously carried out within one belt pressing machine, running stability of the sheet increases so that precision in film thickness is enhanced. Further, since cooling is carried out after heat rolling while applying a pressure, it is easy to maintain the orientation state of molecular chains so that the elastic recovery rate can be more surely reduced.

In addition, in the case where the heat rolling temperature of the pressure roller type double belt pressing machine is at −30° C. or higher and −10° C. or lower of the melting point of the polyolefin resin, and the cold pressurizing is carried out at 40° C. or lower, the sheet can be deformed under pressure at a suitable viscosity during the heat rolling. Moreover, the orientation state of molecular chains can be maintained at a suitable temperature during the cold pressurizing. Accordingly, it is possible to more surely obtain films having a thin film thickness and a high strength.

The above-described effects can be similarly obtained with respect to compositions containing a crosslinkable, double bond-containing thermoplastic elastomer. Moreover, in the case where a double bond is contained, heat resistance of porous films can be enhanced due to crosslinking.

It should further be apparent to those skilled in the art that various changes in form and detail of the invention as shown and described above may be made. It is intended that such changes be included within the spirit and scope of the claims appended hereto.

This application is based on Japanese Patent Application No. 2002-312507 filed Oct. 28, 2002, the disclosure of which is incorporated herein by reference in its entirety.

What is claimed is:

1. A process of producing porous films comprising the steps of melt kneading a composition comprising a polyolefin resin, a thermoplastic elastomer and a solvent; extruding and cooling the melt kneaded material into a sheet molding; rolling the sheet molding; and stretching and desolvating the rolled sheet molding, wherein the rolling is carried out under a condition such that the sheet molding after rolling has an elastic recovery rate as calculated by the following equation (1) of 20% or less:
Elastic recovery rate (r) (%)=100×(t−t₀)/t₀ (1)
wherein t₀ represents a minimum clearance of a sheet rolling section in the rolling; and t represents a sheet thickness in the elastic recovery state after pressure release.

2. The process of producing porous films as claimed in claim 1, wherein the rolling is carried out under a condition such that a rolling coefficient k as calculated by the following equation (2) is 5 (times·min) or more:
Rolling coefficient (k) (times·min)=Rolling ratio (times)×Rolling time (minute) (2)
wherein the rolling ratio means a ratio obtained by dividing a sheet thickness before rolling by a sheet thickness after rolling; and the rolling time means a time when a pressure is acting.

3. The process of producing porous films as claimed in claim 1, wherein the rolling is carried out by a pressure roller type double belt pressing machine.

4. The process of producing porous films as claimed in claim 3, wherein the pressure roller type double belt pressing machine is one in which heat rolling and cold pressurizing are continuously carried out within one belt pressing machine.

5. The process of producing porous films as claimed in claim 4, wherein the heat rolling is carried out at a temperature between (the melting point of the polyolefin resin −30° C.) and (the melting point of the polyolefin resin −10° C.), and the cold pressurizing is carried out at 40° C. or lower.

6. The process of producing porous films as claimed in claim 1, wherein the composition further comprises a crosslinkable, double bond-containing thermoplastic elastomer.

7. A process of producing battery separators, which comprises preparing a battery separator by the process of producing porous films as claimed in claim 1.
